(19) United States
(12) Patent Application Publication
(10) Pub. No.: US 2008/0194999 A1
(43) Pub. Date: Aug. 14, 2008

(54) ULTRASONIC TREATMENT APPARATUS AND TREATMENT METHOD

(76) Inventors: Norihiro Yamaha, Hachioji-shi (JP); Yuusuke Tadami, Hachioji-shi (JP); Mitsumasa Okada, Hachioji-shi (JP); Hideto Yoshimine, Hachioji-shi (JP); Masashi Yamada, Sagamihara-shi (JP)

Correspondence Address: OSTROLENK FABER GERB & SOFFEN, 1180 AVENUE OF THE AMERICAS, NEW YORK, NY, 100368403, US

(21) Appl. No.: 11/673,343

(22) Filed: Feb. 9, 2007

(51) Int. Cl. A61H 1/00

(52) U.S. Cl. 601/2

(57) ABSTRACT

An ultrasonic treatment apparatus includes an ultrasonic transducer to generate ultrasonic vibration, a probe a proximal end of which is connected to the ultrasonic transducer and which extends from a proximal end side to a distal end side, and a treatment portion which includes at least one recess formed on the side of the probe and treats a living tissue by ultrasonic vibration generated by the ultrasonic transducer.

### BACKGROUND OF THE INVENTION

1. Field of the Invention

The invention relates to an ultrasonic treatment apparatus for treating a living tissue by using ultrasonic vibration and a treatment method of using such an ultrasonic treatment apparatus.

2. Description of the Related Art

In an ultrasonic treatment apparatus, ultrasonic vibration is generated by an ultrasonic transducer, a probe is oscillated ultrasonically and a living tissue is treated by a treatment portion in the distal end portion of the probe. As an example of such operation, there is an endoscopic surgical operation where an ultrasonic treatment apparatus is inserted into a body cavity through a trocar, a fatty tissue is emulsified, fractured and whereby removed, and a funicular tissue such as a blood vessel and a lymph vessel is exposed. As another example, there is an endoscopic submucosa ablation operation where an ultrasonic treatment apparatus is inserted into a body cavity through an accessory channel of endoscope and a submucosa is fractured and whereby ablated.

An ultrasonic treatment apparatus used for the above purposes preferably has high energy efficiency and sufficient treatment power. In particular, as the treatment power is increased by cavitation generated in a treatment portion by ultrasonic vibration of a probe, it is preferable to promote cavitation. From this point of view, ultrasonic vibration of various frequency, amplitude and vibration velocity is employed in the ultrasonic treatment apparatus, as disclosed in U.S. Pat. Nos. 4,992,902 and 4,063,557.

### BRIEF SUMMARY OF THE INVENTION

According to an aspect of the invention, there is provided an ultrasonic treatment apparatus including: an ultrasonic transducer to generate ultrasonic vibration; a probe a proximal end of which is connected to the ultrasonic transducer and which extends from a proximal end side to a distal end side; and a treatment portion which is formed in a distal end portion of the probe, includes at least one recess formed on the side of the probe and treats a living tissue by ultrasonic vibration generated by the ultrasonic transducer.

According to another aspect of the invention, there is provided a treatment method including: moving a distal end portion of a probe extending from a proximal end side to a distal end side in the direction crossing a central axis of the probe; applying a side of a distal end portion of the probe provided with at least one recess to a living tissue; and treating a living tissue applied by the side of a distal end portion of the probe by ultrasonic vibration of the probe.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a side sectional view of an ultrasonic treatment apparatus according to a first embodiment of the invention;

FIG. 2A is a perspective view of a treatment portion of the ultrasonic treatment apparatus according to the first embodiment of the invention;

FIG. 2B is a perspective view of a treatment portion of an ultrasonic treatment apparatus according to a first modification of the first embodiment of the invention;

FIG. 2C is a perspective view of a treatment portion of an ultrasonic treatment apparatus according to a second modification of the first embodiment of the invention;

FIG. 2D is a perspective view of a treatment portion of an ultrasonic treatment apparatus according to a third modification of the first embodiment of the invention;

FIG. 3 is a schematic diagram for explaining a transverse cross section area of a rod portion and a total transverse cross section area of a groove in the treatment portion of the ultrasonic treatment apparatus according to the first embodiment of the invention;

FIG. 4A is a perspective view for explaining the method of using the ultrasonic treatment apparatus according to the first embodiment of the invention;

FIG. 4B is an enlarged side sectional view for explaining the method of using the ultrasonic treatment apparatus according to the first embodiment of the invention;

FIG. 5A is a graph showing a tissue suction volume with respect to a distal end portion total transverse cross section area in the ultrasonic treatment apparatus according to the first embodiment of the invention;

FIG. 5B is a graph showing a tissue suction volume with respect to a ratio of transverse cross section areas in the ultrasonic treatment apparatus according to the first embodiment of the invention;

FIG. 6 is a view showing an endoscope system according to a second embodiment of the invention;

FIG. 7 is a longitudinal side cross sectional view showing distal end portions of an endoscope and an ultrasonic treatment apparatus according to the second embodiment of the invention;

FIG. 8 is a perspective view of a treatment portion of the ultrasonic treatment apparatus according to the second embodiment of the invention;

FIG. 9 is a flowchart showing a method of using the endoscope system according to the second embodiment of the invention;

FIG. 10A is a perspective view showing a staining process in the method of using the endoscope system according to the second embodiment of the invention;

FIG. 10B is a perspective view showing a marking process in the method of using the endoscope system according to the second embodiment of the invention;

FIG. 10C is a perspective view showing a local injection process in the method of using the endoscope system according to the second embodiment of the invention;

FIG. 10D is a perspective view showing a periphery incision process in the method of using the endoscope system according to the second embodiment of the invention;

FIG. 10E is a perspective view showing an endoscope bending motion in an ablation process in the method of using the endoscope system according to the second embodiment of the invention;

FIG. 10F is a perspective view showing an ablation process in the method of using the endoscope system according to the second embodiment of the invention;

FIG. 11 is a perspective view showing an ablation process in an endoscope system of related art;

FIG. 12A is a perspective view of a treatment portion of an ultrasonic treatment apparatus according to a third embodiment of the invention;

FIG. 12B is a perspective view of a treatment portion of an ultrasonic treatment apparatus according to a first modification of the third embodiment of the invention;

FIG. 12C is a perspective view of a treatment portion of an ultrasonic treatment apparatus according to a second modification of the third embodiment of the invention;

FIG. 12D is a transverse cross sectional view of a treatment portion of an ultrasonic treatment apparatus according to a third modification of the third embodiment of the invention;

FIG. 13A is a perspective view of a distal end portion of an ultrasonic treatment apparatus according to a fourth embodiment of the invention;

FIG. 13B is a perspective view of a treatment portion of an ultrasonic treatment apparatus according to a first modification of the fourth embodiment of the invention;

FIG. 13C is a perspective view of a treatment portion of an ultrasonic treatment apparatus according to a second modification of the fourth embodiment of the invention;

FIG. 13D is a transverse cross sectional view of a treatment portion of an ultrasonic treatment apparatus according to a third modification of the fourth embodiment of the invention;

FIG. 14 is a perspective view of a treatment portion of an ultrasonic treatment apparatus according to a fifth embodiment of the invention;

FIG. 15A is a perspective view showing a method of using an endoscope system according to the fifth embodiment of the invention;

FIG. 15B is an enlarged side cross sectional view showing a method of using the endoscope system according to the fifth embodiment of the invention;

FIG. 16A is a side view of a treatment portion of an ultrasonic treatment apparatus according to a sixth embodiment of the invention;

FIG. 16B is a side view of a treatment portion of an ultrasonic treatment apparatus according to a modification of the sixth embodiment of the invention;

FIG. 17A is a perspective view of a treatment portion of an ultrasonic treatment apparatus according to a seventh embodiment of the invention; and

FIG. 17B is a longitudinal cross sectional view of a treatment portion of an ultrasonic treatment apparatus according to a modification of the seventh embodiment of the invention.

### DETAILED DESCRIPTION OF THE INVENTION

Embodiments of the invention will be explained hereinafter with reference to the accompanying drawings.

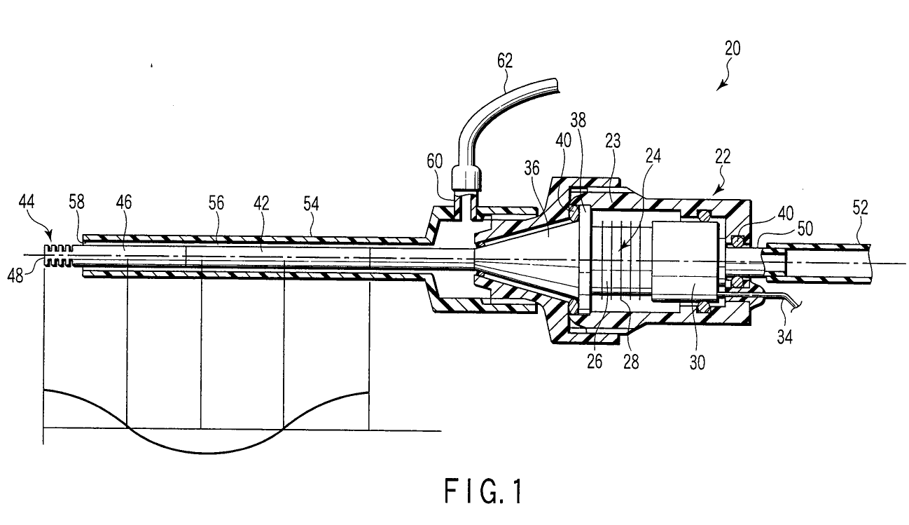

FIG. 1-FIG. 5B show a first embodiment of the invention and modifications thereof.

Reference to FIG. 1, an ultrasonic treatment apparatus 20 according to this embodiment has a grip portion 22 held by an operator. An ultrasonic transducer 24 is housed in a cover 23 of the grip portion 22. The ultrasonic transducer 24 is formed by laminating piezoelectric elements 26 and electrodes 28. A back plate 30 is connected to the proximal end of the ultrasonic transducer 24. A power line extends from the electrode 28 of the ultrasonic transducer 24 and lead to a power cord 34 extending from the proximal end of the grip portion 22. The power cord 34 is connected to an ultrasonic drive apparatus for supply power to the ultrasonic transducer 24.

A tapered horn 36 for amplifying ultrasonic vibration is connected to the distal end portion of the ultrasonic transducer 24. The flange 38 in the proximal end of the horn 36 is held watertightly by an inside surface of the cover 23 of the grip portion 22. At the distal end of the horn 36, the proximal end of a circular cylindrical rod shaped probe 42 extending from the proximal end to the distal end is removably connected by a screw coupling at an anti-node position of ultrasonic vibration. The distal end of the probe 42 takes a position of anti-node of ultrasonic vibration. A treatment portion 44 described later for treating a living tissue is formed in the distal end portion of the probe 42.

A suction path 46 is formed along the central axis of the probe 42, horn 36, ultrasonic transducer 24 and back plate 30. The distal end of the suction path 46 opens in the distal end portion of the probe 42 and forms a suction opening 48. The proximal end of the suction path 46 connects to a suction connecter 50. The suction connecter 50 penetrates into the proximal end wall of the cover 23 of the grip portion 22 watertightly through an O-ring 40. A suction tube 52 connects to the suction connecter 50. The suction tube 52 connects to a suction apparatus.

An outer tube 54 is provided onto the probe 42. A liquid supply path 56 is formed between the outside surface of the probe 42 and the inside surface of the outer tube 54. The distal end of the liquid supply path 56 forms a ring shaped liquid supply opening 58 at the distal end of the outer tube 54. The proximal end of the liquid supply path 56 connects to a liquid supply connecter 60 projecting at the proximal end of the outer tube 54. A liquid supply tube 62 connects to the liquid supply connecter 60. The liquid supply tube 62 connects to a liquid supply apparatus.

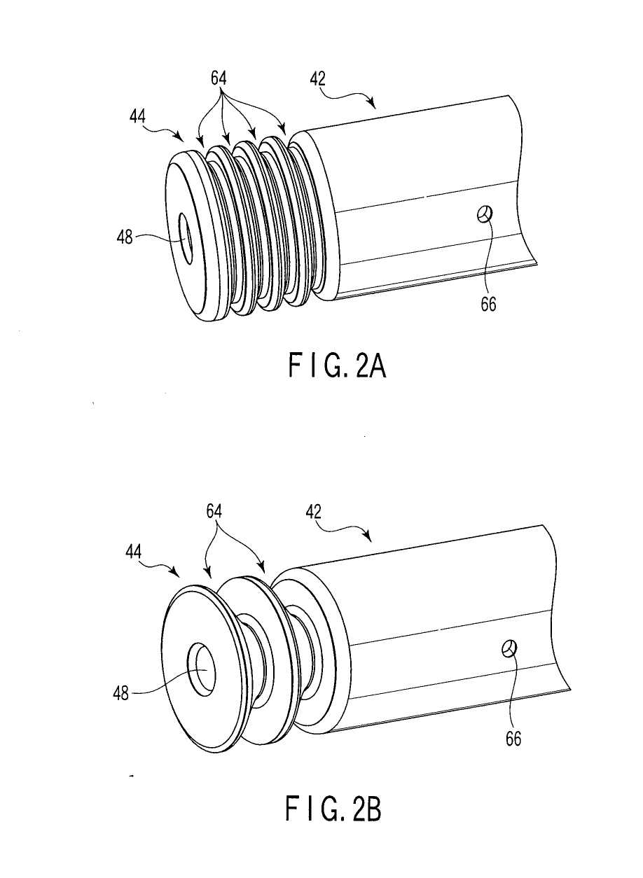

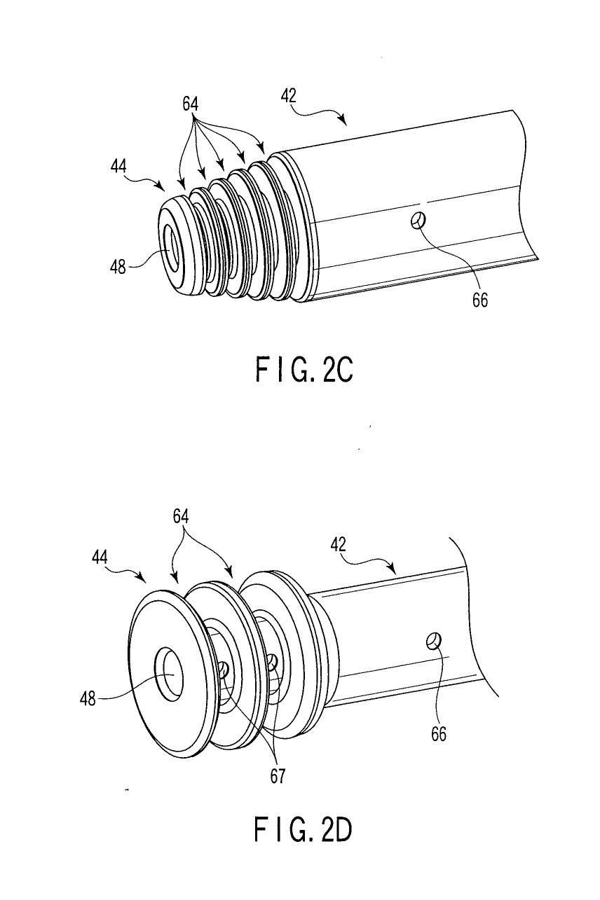

Reference to FIG. 2A, in the treatment portion 44 of this embodiment, a groove 64 as a recess extends over all circumference of the probe 42 on the side of the distal end portion of the probe 42. A plurality of such groove 64 is arranged side by side in the central axial direction of the probe 42. The cross section perpendicular to the peripheral direction of each groove 64 is almost rectangular. Cavitation is promoted on the distal end and proximal end side ring shaped surfaces of each groove 64. A side hole 66 is formed on the proximal end side of the most proximal end groove 64. The side hole 66 extends in the radial direction of the probe 42 and connects to the suction path 46.

Reference to FIG. 2B, in the groove 64 of a first modification of this embodiment, a tapered surface is formed with the outside diameter increasing from the proximal end side ring shaped surface to the distal end side. Cavitation is promoted in the proximal side ring shaped surface and tapered surface of each groove 64.

Reference to FIG. 2C, in the treatment portion 44 of a second modification of this embodiment, the peripheral surface of the distal end portion of the probe 42 is tapered with the outside diameter decreasing to the distal end side in order to reduce disturbance of view field by the distal end portion of the probe 42. A plurality of grooves 64 is formed in this tapered part as in the first embodiment, and the depth of the more distal groove 64 is shallower. Cavitation is promoted in the distal end and proximal end side ring shaped surfaces of each groove 64, as in the first embodiment.

Reference to FIG. 2D, in the treatment portion 44 of a third modification of this embodiment, a suction opening 67 is formed on the side of the probe 42. The suction opening 67 opens at the bottom of the groove 64, and extends in the radial direction and connects to the suction path 46. A living tissue emulsified and fractured by the cavitation generated in each groove 64 is sucked into the suction path 46 through the suction opening 67. In this modification, by forming the suction opening 67 on the side of the probe 42, much more living tissue can be sucked, and the suction performance is improved. Similarly, in the treatment portion 44 of the first embodiment and its modification shown in FIG. 2A-2C, the suction opening 67 may be formed on the side of the probe 42.

f is a frequency of ultrasonic vibration in the ultrasonic treatment apparatus 20 of this embodiment and its modification and 20.0 kHz≦f≦50.0 kHz. The frequency f is lower, cavitation is more promoted. When the frequency f is higher than 50.0 kHz, necessary cavitation is not obtained. The frequency lower than 20.0 kHz is in audible range. When the frequency f is lower than 20.0 kHz, a strange noise is generated.

In this embodiment and its modification, for example, f=47.0 and 23.5 kHz are used.

λ is a ultrasonic vibration wavelength, E is a Young's modulus, ρ is a density of the probe 42 and λ={(E/ρ)^{1/2}}/f.

In this embodiment and its modification, for example, the probe 42 is made of Ti alloy, and E=108.0 Gpa and ρ=4.4 g/cm³. When f=47.0 kHz, λ=104.0 mm. When f=23.5 kHz, λ=208.0 mm.

The probe 42 may be made of material other than Ti alloy, for example, duralumin. In this case, E=75.0 Gpa and ρ=2.8 g/cm³. When f=47.0 Hz, λ=109.0 mm. When f=23.5 kHz, λ=218.0 mm.

1 is the distance from the distal end of the probe 42 to the most proximal end of the groove 64 in the central axial direction, the distance l is λ/100.0≦l≦λ/8.0. When the distance l is smaller than λ/100.0, the area of the groove 64 becomes too small and treatment becomes difficult. At the position of λ/8.0 from the distal end of the probe 42, the ultrasonic vibration amplitude is approximately 70% of that at the distal end of the probe. When the distance 1 is larger than λ/8.0, the amplitude becomes too low in the area of the proximal end side farther than λ/8.0 and necessary treatment power is not obtained. Preferably, the distance l is λ/20.0≦l≦λ/12.0. In this case, the area of the groove 64 is appropriate size, the amplitude decrease is suppressed to the extent that the ultrasonic vibration amplitude is approximately 80% and sufficient treatment power is obtained.

In this embodiment and its modification, for example, f=47.0 kHz, λ=104.0 mm, l=λ/17.0=6.0 mm and f=23.5 kHz, λ=208.0 mm, l=λ/34.0=6.0 mm are used.

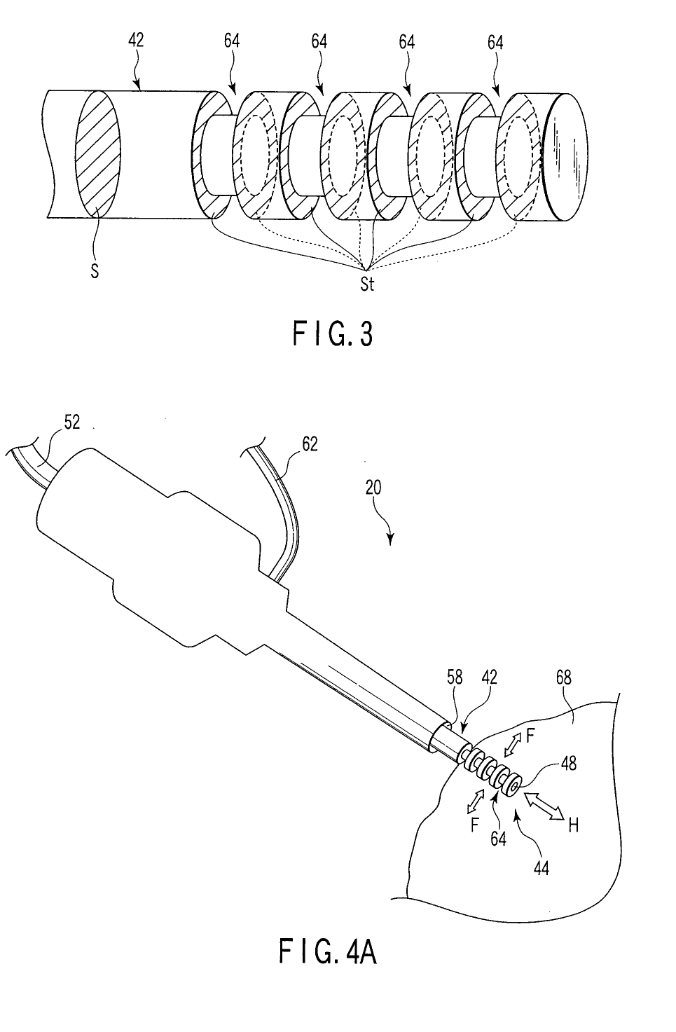

In the treatment portion 44, only an area component perpendicular to the central axis of the probe 42 of the surface area of the groove 64 contributes generation of cavitation. Reference to FIG. 3, a transverse cross section area S of the rod portion is a area of a transverse cross section of the probe 42 perpendicular to the central axis of the probe 42 and a total transverse cross section area St of the groove 64 is a total area of projection surfaces of the groove 64 onto the transverse cross section perpendicular to the central axis of the probe 42. The ratio of transverse cross section areas St/S is 3.0≦St/S≦15.0. When the ratio of the transverse cross section areas St/S is smaller than 3.0, cavitation is not sufficiently promoted and necessary treatment power is not obtained. When the ratio of the transverse cross section areas St/S is larger than 15.0, the load to the ultrasonic transducer 24 is so large that the ultrasonic transducer 24 fails to operate. Preferably, the ratio of the transverse cross section areas St/S is 6.0≦St/S≦10.0. In this case, sufficient treatment power can be obtained and the load to the ultrasonic transducer 24 has a margin.

In the embodiment shown in FIG. 2A, for example, the transverse cross section area S of the rod portion=48.4 mm², the total transverse cross section area St of the groove 64=178.4 mm², and the ratio of transverse cross section areas St/S=3.7 are used. In the first modification of the embodiment shown in FIG. 2B, for example, the transverse cross section area S of the rod portion=48.4 mm², the total transverse cross section area St of the groove 64=178.9 mm² and the ratio of transverse cross section areas St/S=3.6 are used. In the second modification of the embodiment shown in FIG. 2C, for example, the transverse cross section area S of the rod portion=48.4 mm², the total transverse cross section area St of the groove 64=204.1 mm², and the ratio of transverse cross section areas St/S=4.2 are used.

v is a vibration velocity of ultrasonic vibration and A is a amplitude. The vibration velocity v=2π×Frequency f×Amplitude A. If the groove 64 is not formed in the treatment portion 44, the vibration velocity needs to be 30 m/sec≦v≦50 m/sec to obtain sufficient treatment power. If sufficient treatment power is obtained when the vibration velocity v is 5 m/sec≦v≦15 m/sec, then the energy efficiency is high.

In this embodiment and modification, sufficient treatment power is obtained with f=47.0 kHz and A=50.0 μm, and v=14.8 m/sec. Sufficient treatment power is also obtained with f=23.5 kHz and A=100.0 μm, and v=14.8 m/sec.

Next, an explanation will be given on the method of using the ultrasonic treatment apparatus 20 of this embodiment by taking an example of an operation where removing a fatty tissue 68 and exposing a funicular tissue.

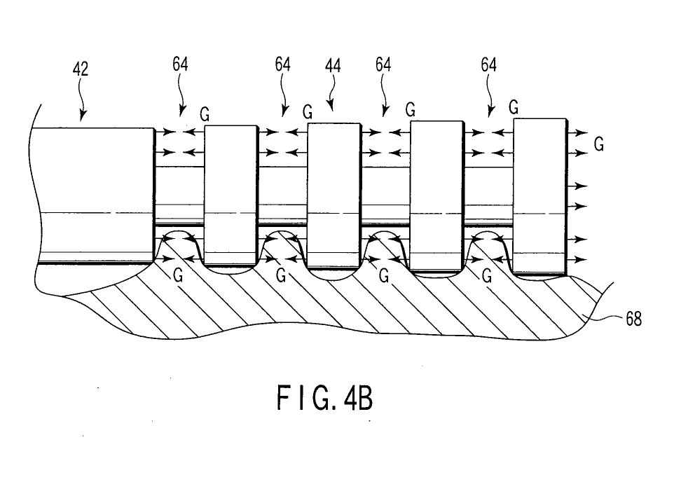

Reference to FIGS. 4A and 4B, an endoscope is inserted into a body cavity and the distal end portion of the ultrasonic treatment apparatus 20 is inserted into a body cavity through a trocar. Under observation through the endoscope, the distal end portion of the ultrasonic treatment apparatus 20 is moved in the direction crossing the central axis of the probe 42 as indicated by the arrow F in FIG. 4A and the side of the distal end portion of the probe 42 is applied to the fatty tissue 69 around a funicular tissue such as a blood vessel and a lymph vessel. The fatty tissue 68 is led into the groove 64 on the side of the distal end portion of the probe 42 and emulsified and fractured by the ultrasonic vibration of the probe 42. In this time, as indicated by arrow G in FIG. 4B, cavitation is generated on the distal end and proximal end side ring shaped surfaces of the groove 64. The cavitation promotes emulsification and fracture. If necessary, liquid is supplied from the liquid supply opening 58 to the object of treatment by the liquid supply apparatus through the liquid supply tube 62 and liquid supply path 56. Further, the distal end portion of the probe 42 is moved along the funicular tissue in the direction crossing the central axis of the probe 42, the fatty tissue 68 around the funicular tissue is removed and the funicular tissue is exposed. As shown by the arrow H in FIG. 4, the emulsified and fractured fatty tissue is sucked from the suction opening 48 together with irrigation liquid through the suction path 46 and suction tube 52, and collected in the suction apparatus.

Therefore, the ultrasonic treatment apparatus 20 of this embodiment provides the following effects.

In the ultrasonic treatment apparatus 20 of this embodiment, the groove 64 is formed on the side of the distal end portion of the probe 42. Cavitation is promoted by the groove 64 on the side of the distal end portion of the probe 42, and sufficient treatment power is obtained. As a result, treatment can be performed by the side of the distal end portion of the probe 42.

As treatment can be performed by the side of the distal end portion of the probe 42, treatment is possible by-moving the distal end portion of the probe 42 in the direction crossing the central axis of the probe 42. This is suitable for operation where removing the fatty tissue 68 and exposing a funicular tissue.

Further, the frequency f is 20.0 kHz≦f≦50.0 kHz, the distance l is λ/100.0≦l≦λ/8.0, and the ratio of transverse cross section areas St/S is 3.0≦St/S≦15.0 so that sufficient treatment power is obtained and the vibration velocity v becomes 5 m/sec ≦v≦15 m/sec. Namely, sufficient treatment power is obtained with high energy efficiency.

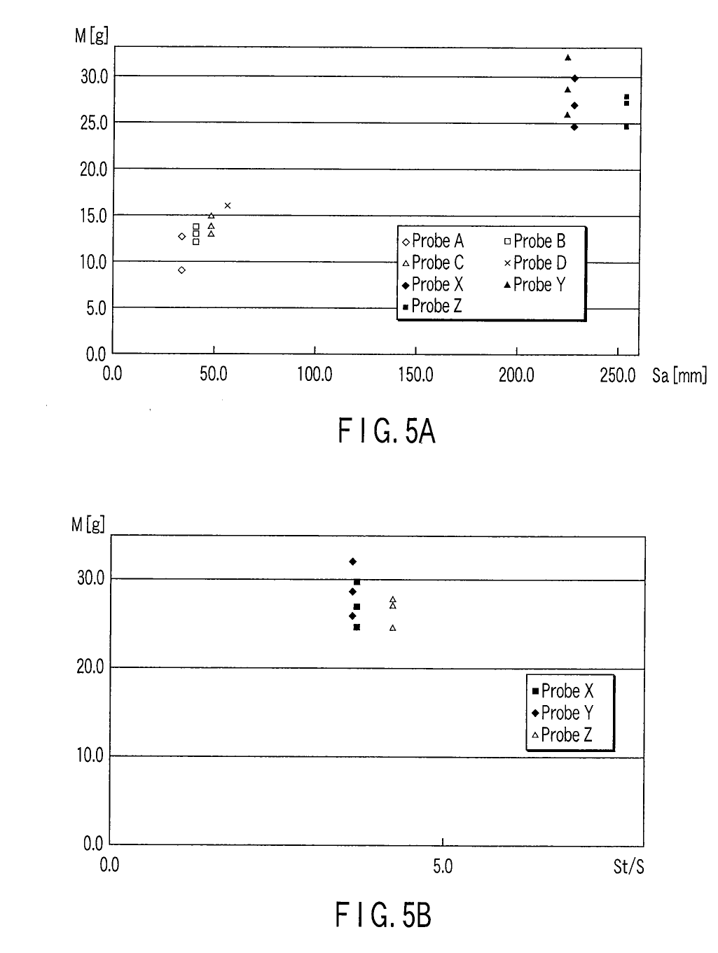

Reference to FIGS. 5A and 5B, explanation will now be given on the results of experiment.

A total distal end transverse cross section area Sa=S+St is the total of the transverse cross section area S of the rod portion and the total transverse cross section area St of the groove 64 and a tissue suction amount M is a suction amount of the emulsified and fractured fatty tissue 68.

FIG. 5A shows the tissue suction amount M with respect to the total distal end transverse cross section area Sa. Probes A, B, C and D are probes not including the groove 64 in the distal end portion and different in the cross section area S of the rod portion. Probes X, Y and Z are the probes 42 of this embodiment, first modification and second modification, respectively. FIG. 5A indicate that the tissue suction amount is extremely increased by forming the groove 64 in the distal end portion of the probe 42.

FIG. 5B shows the tissue suction amount M with respect to the ratio of the transverse cross section areas St/S.

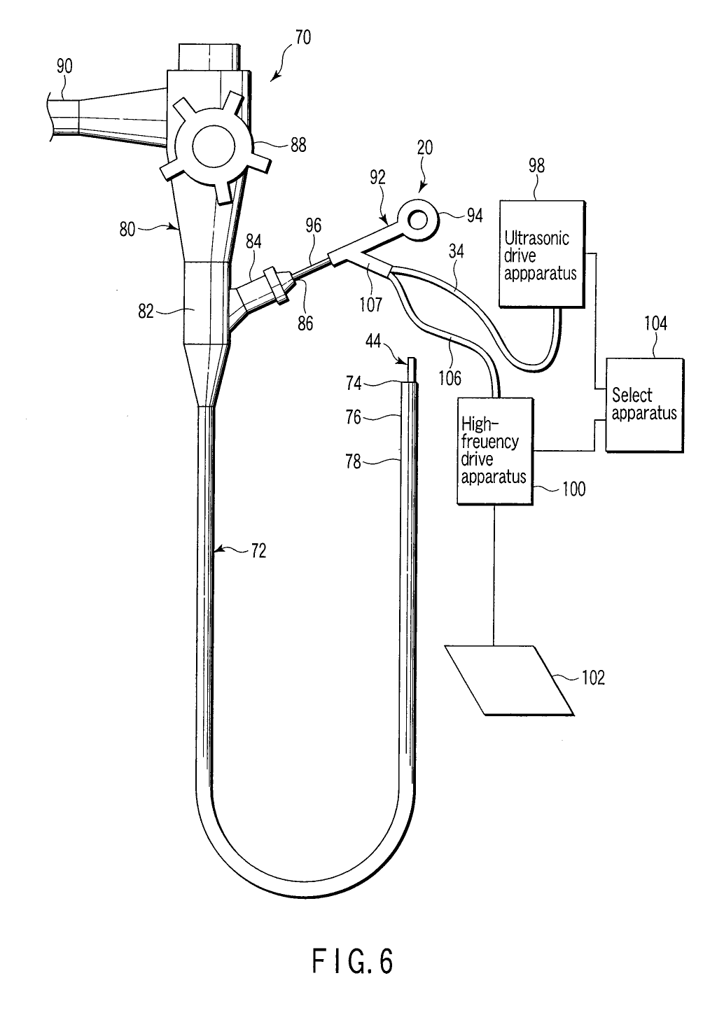

FIGS. 6-11 show a second embodiment of the invention.

Reference to FIG. 6, a flexible endoscope 70 of an endoscope system of this embodiment has an endoscope insertion portion 72 to be inserted into a body cavity. The endoscope insertion portion 72 is formed by connecting a distal end hard portion 74, a bending portion 76 and a long flexible tube portion 78 sequentially from the distal end side. An endoscope control portion 80 is connected to the proximal end of the endoscope insertion portion 72. An endoscope grip portion 82 held by an operator is provided on the distal end side of the endoscope control portion 80. The endoscope grip portion 82 is provided with an accessory insertion opening 84 to insert an accessory. An accessory channel 86 for inserting an accessory is extended from the accessory insertion opening 84 to the distal end of the endoscope 70. The proximal end of the endoscope control portion 80 is provided with a bending operation knob 88 for bending the bending portion 76. A universal cord 90 extends from the proximal end of the endoscope control portion 80, and connects to a light source apparatus, a video processor, etc. Illumination light from a light source is applied to an observation object from the distal end of the endoscope 70, an image signal of an observation image taken by an image pick up unit at the distal end of the endoscope 70 is output to a video processor and the observation image is displayed in a display apparatus.

The endoscope system has an ultrasonic drive apparatus 98 for supplying electric power to the ultrasonic treatment apparatus 20. The ultrasonic treatment apparatus 20 functions also as a diathermy knife and the endoscope system has a high-frequency drive apparatus 100 for supply a high-frequency current. An opposite electrode plate 102 is connected to the high-frequency drive apparatus 100. These ultrasonic drive apparatus 98 and high-frequency drive apparatus 100 are connected to a select apparatus 104 for selecting one of these drive apparatuses. A power cord 34 and a current cord 106 extend from the ultrasonic drive apparatus 98 and high-frequency drive apparatus 100 respectively.

The proximal end of the ultrasonic treatment apparatus 20 is provided with a control portion 92 for advancing/retreating the ultrasonic treatment apparatus 20. The proximal end of the control portion 92 is provided with a ring 94 held by an operator. The power cord 34 and current cord 106 lead into the control portion 92 through a port 107 of the control portion 92. The distal end of the control portion 92 connects to the proximal end of a long flexible insertion portion 96. The insertion portion 96 is inserted from the accessory insertion opening 84 to the distal end of the endoscope 70 through the accessory channel 86 and movable forward and backward. The power cord 34 and current cord 106 are inserted into the insertion portion 96 and extended to the distal end of the ultrasonic treatment apparatus 20.

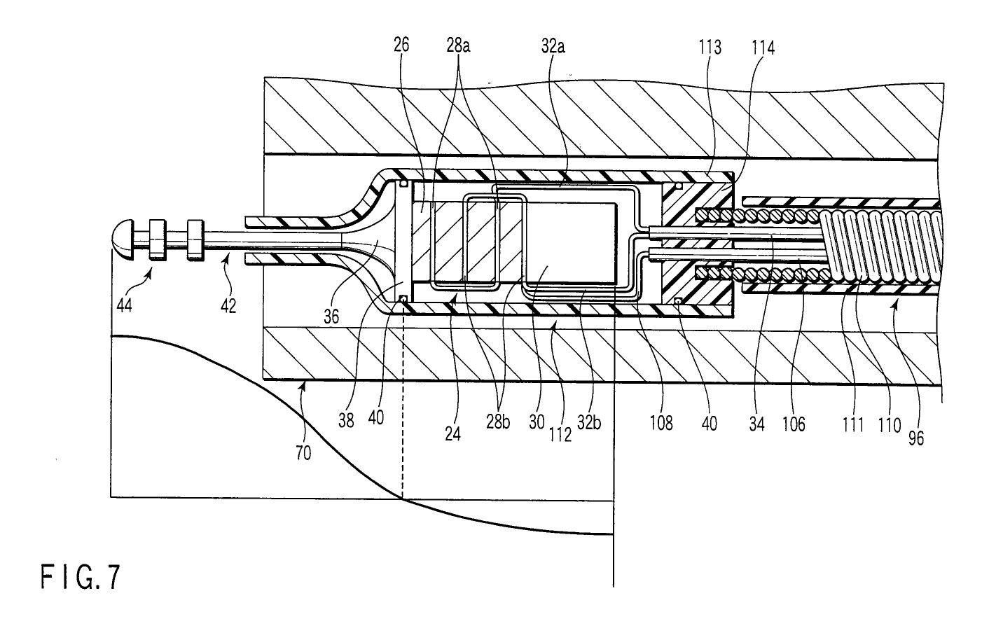

Reference to FIG. 7, the insertion portion 96 of the ultrasonic treatment apparatus 20 is formed by providing a sheath 111 onto a coil shaft 110. The distal end of the coil shaft 110 is fixed to a partition 114 of a treatment unit 112. The partition 114 is held watertightly by the inside surface of the proximal end of a substantially circular cylindrical tube shaped cylinder 113 through an O-ring 40. By advancing or retreating the insertion portion 96 with respect to the endoscope 70, the distal end of the treatment unit 112 can be projected from or sunk into the distal end of the endoscope 70.

The power cord 34 and current cord 106 extend from the distal end of the insertion portion 96 and lead into the cylinder 113 through the partition 114. The ultrasonic transducer 24 is housed in the cylinder 113. The ultrasonic transducer 24 is formed by laminating piezoelectric elements 26, positive electrodes 28a and negative electrodes 28b. A positive power line 32a and a negative power line 32b extending from the power cord 34 connects to the positive electrodes 28a and negative electrodes 28b of the ultrasonic transducer 24, respectively. A current line 108 extending from the current cord 106 also connects the negative electrode 28b. It is possible to flow a high-frequency current through a patient body between the negative electrode 28b and the opposite electrode plate 102 provided outside a patient body.

The back plate 30 is provided in the proximal end side of the ultrasonic transducer 24, and the horn 36 is provided in the distal end side thereof. These back plate 30 and horn 36 are fixed to each other to hold the ultrasonic transducer 24. The horn 36 is tapered to amplify ultrasonic vibration, and may be any of step, exponential, conical and catenoidal. The flange 38 of the horn 36 is held watertightly by the inside surface of the cylinder 113 through the O-ring 40. The substantially circular cylindrical rod shaped probe 42 extends from the distal end of the horn 36, from the proximal end side to the distal end side. To reduce the size, the horn 36 and probe 42 are made as one body and the total length from the rear end of the ultrasonic transducer 24 to the distal end of the probe 42 is half of an ultrasonic vibration wavelength λ (λ/2). The flange 38 of the horn 36 takes the position of node of ultrasonic vibration and the distal end of the probe 42 takes the position of anti-node thereof. The distal end of the cylinder 113 is tapered, then circular cylindrical tube shaped, and extends to the distal end side corresponding to the shapes of the horn 36 and probe 42.

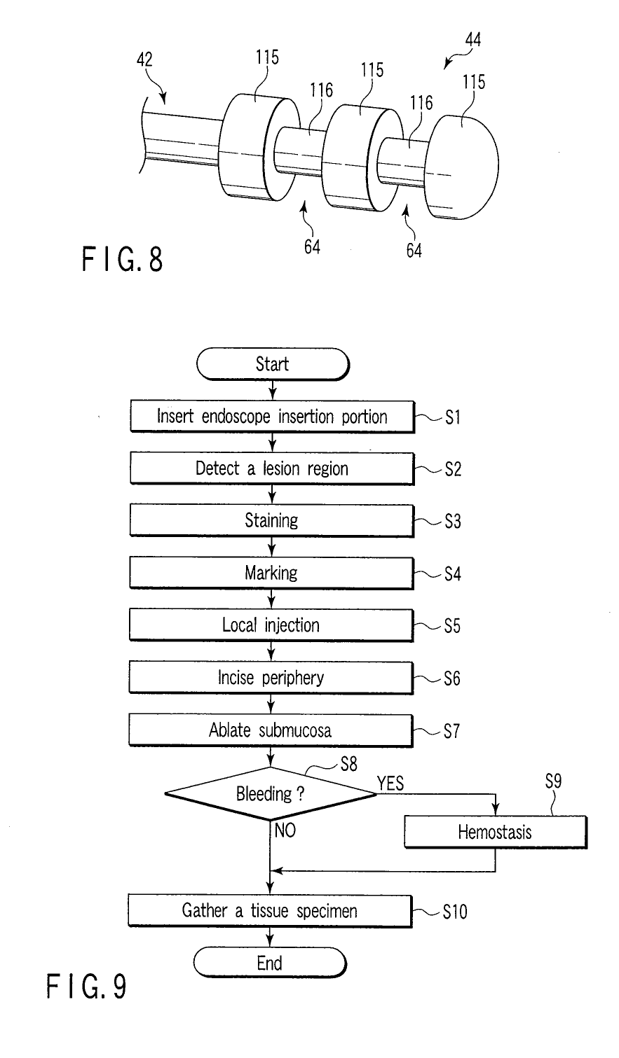

Reference to FIG. 8, the treatment portion 44 is provided in the distal end portion of the probe 42. The probe 42 is substantially circular cylindrical rod shaped. The distal end portion of the probe 42 has a larger diameter than the proximal end portion thereof. As in the first embodiment, the groove 64 as a recess extends over all circumference of the probe 42 on the side of the distal end portion of the probe 42. A plurality of such grooves 64 is arranged side by side in the central axial direction of the probe 42. The groove 64 is formed so that in the treatment portion 44, a circular cylindrical thick portion 115 and a circular cylindrical thin portion 116 are sequentially and coaxially arranged in the central axial direction of the probe 42. Cavitation is promoted in the distal end and proximal end side ring shaped surfaces of each groove 64. The distal end portion of the probe 42 is hemisphere, and suppresses cavitation.

In this embodiment, third to sixth embodiments and their modifications, the ultrasonic vibration frequency f is 75.0 kHz≦f≦150.0 kHz. When the frequency f is smaller, cavitation is more promoted and when the frequency f is larger than 150.0 kHz, necessary cavitation is not obtained. As described above, the total length from the distal end of the probe 42 to the proximal end of the ultrasonic transducer 24 corresponds to a half-wave of ultrasonic vibration, and when the frequency f is smaller, the total length is larger. When the frequency is smaller than 75.0 kHz, the total length is larger than 50.0 mm. This is too large to insert into the accessory channel 86 of the endoscope 70, and inconvenient. Preferably, the frequency f=100.0±15 kHz. In this case, sufficient cavitation is obtained, and the total length becomes 25.00 mm and easy to use.

In the second to sixth embodiment and their modifications, for example, f=100.0 kHz is used.

As in the first embodiment, the distance l is λ/100.0≦l≦λ/8.0, preferably λ/20.0≦l≦λ/12.0. When f=100.0 kHz, λ/100.0=0.49 mm, and λ/20.0 =2.4 mm.

In the second to sixth embodiment and their modifications, for example, the frequency f=100.0 kHz and l=λ/12.5=3.9 mm are used.

As in the first embodiment, the ratio of transverse cross section areas St/S is 3.0≦St/S≦15.0, preferably 6.0≦St/S≦10.0.

In the second to sixth embodiment and their modifications, for example, S=1.23 mm², St=14.6 mm² and St/S=11.7 are used. When the transverse cross section of the rod portion is circular, φ=1.25 mm.

As in the first embodiment, if sufficient treatment power is obtained when the vibration velocity v is 5 m/sec≦v≦15 m/sec, then the energy efficiency is high.

In the second to sixth embodiment and their modifications, sufficient treatment power is obtained with f=100.0 kHz, λ=20.0 μm, and v=12.0 m/sec.

Next, an explanation will be give on a method of using the ultrasonic treatment apparatus 20 of this embodiment, taking an example of operation where gathering a tissue specimen of a lesion region on submucosa. In the inside wall of a body cavity, a muscular layer, a submucosa and a mucus are sequentially laminated to the surface side. The ultrasonic treatment apparatus 20 is used for fracturing and ablating the submucosa.

Steps of the method will be explained with reference to the flowchart of FIG. 9.

Step 1 (S1)

The endoscope insertion portion 72 is inserted into a body cavity.

Step 2 (S2)

The endoscope control portion 80 is operated, the distal end of the endoscope 70 is moved and the visual field of the endoscope 70 is shifted to detect a lesion region 118 on a mucus 117 and place the lesion region within the visual field of the endoscope 70. Thereafter, various treatments are performed under observation through the endoscope 70.

Step 3 (S3)

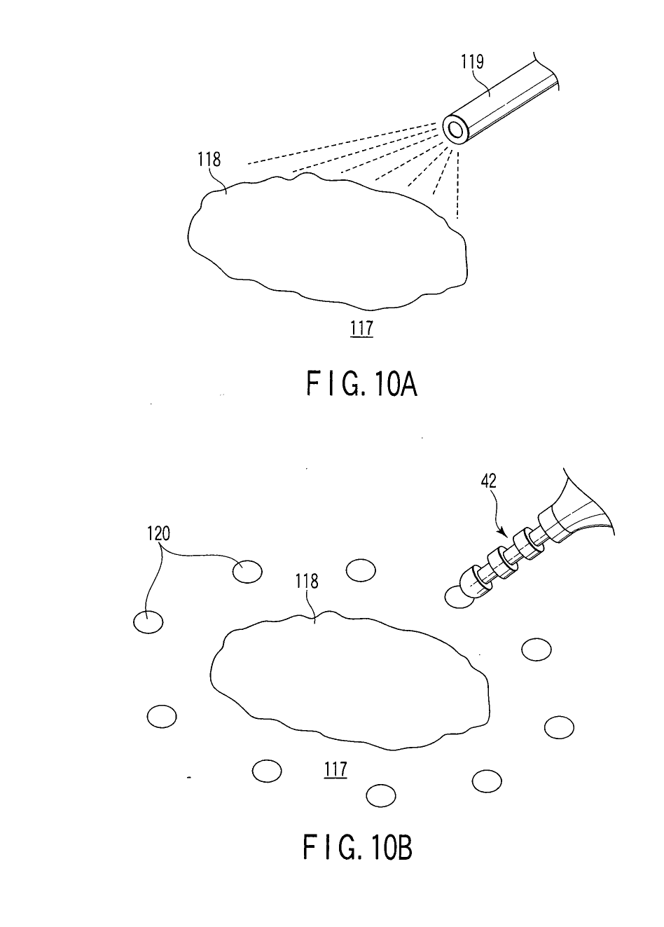

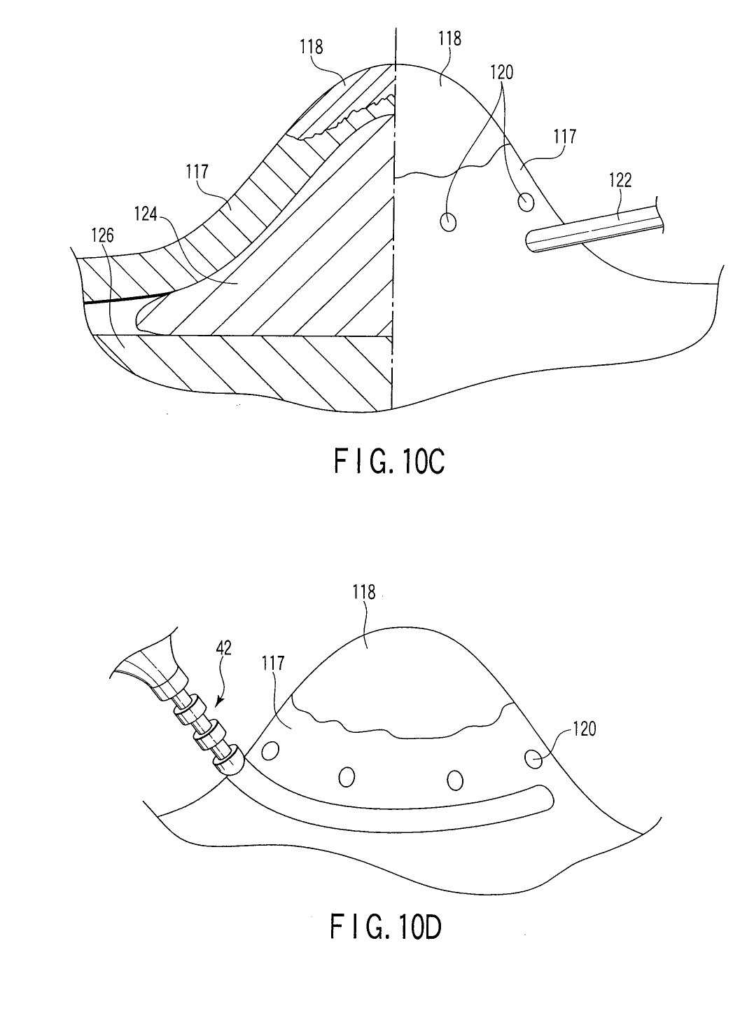

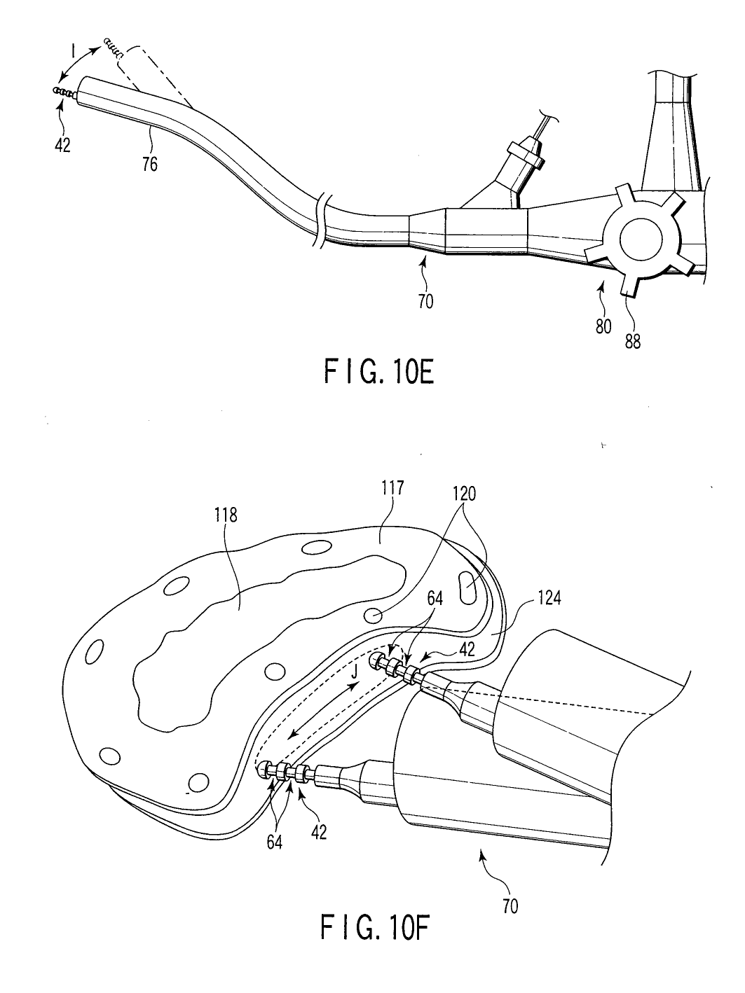

Reference to FIG. 10A, a tube 119 is inserted into the body cavity through the accessory channel 86. A syringe filled with staining agent is connected to the proximal end of the tube 119. The staining agent is sprayed from the syringe to the lesion region 118 through the tube 119 to stain the lesion region 118. Then, the tube 119 is removed from the accessory channel 86.

Step 4 (S4)

Reference to FIG. 10B, the ultrasonic treatment apparatus 20 is inserted into the accessory channel 86, and the probe 42 of the ultrasonic treatment apparatus 20 is projected from the distal end of the endoscope 70. After applying the opposite electrode plate 102 to the surface of patient body, the high-frequency drive apparatus 100 is selected by the select apparatus 104 and actuated to supply a high-frequency current to the negative electrode 28b of the ultrasonic transducer 24 and the probe 42 of the ultrasonic treatment apparatus 20 is used as the diathermy knife. Several portions of the mucus 117 surrounding the stained lesion region 118 is cauterized by the distal end portion of the probe 42 to form spot shaped marks 120. In this way, marking is performed. Then, the ultrasonic treatment apparatus 20 is removed from the accessory channel 86.

Step 5 (S5)

Reference to FIG. 10C, the tube with an injection needle 122 connected to the distal end thereof is inserted into a body cavity through the accessory channel 86. A syringe filled with local injection liquid such as physiological saline solution, glycerol is connected to the proximal end of the tube. The injection needle 122 is inserted into the submucosa 124 under the lesion region 118 from the position more outside than the mark 120 and the local injection liquid is injected to the submucosa 124 through the tube to swell the submucosa 124 and raise the mucus 117 around the lesion region 118. Then, the injection needle 122 and tube is removed from the accessory channel 86.

Step 6 (S6)

Reference to FIG. 10D, the ultrasonic treatment apparatus 20 is inserted into the accessory channel 86 and the probe 42 of the ultrasonic treatment apparatus is projected from the distal end of the endoscope 70. The high-frequency drive apparatus 100 is select by the select apparatus 104 and actuated to supply a high-frequency current to the ultrasonic transducer 24 through the current line 108 and the probe 42 is used as the diathermy knife. The mucus 117 is incised over all circumference surrounding the lesion region 118 on the more outside than the mark 120 by the distal end portion of the probe 42. In this way, periphery incision is performed.

Step 7 (S7)

Reference to FIGS. 10E and 10F, the distal end of the endoscope 70 is moved by operating the endoscope control portion 80 so as to place the probe 42 of the ultrasonic treatment apparatus substantially parallel to the surface of the muscular layer 126 under the submucosa 124. The bending portion 76 of the endoscope 70 is bended as indicated by the arrow I in FIG. 10F by operating the bending operation knob 88B to move the distal end portion of the probe 42 of the ultrasonic treatment apparatus 20 in the direction substantially parallel to the surface of the muscular layer 126 and crossing the central axis of the probe 42 to apply the side of the distal end portion of the probe 42 to the submucosa 124 exposed by the periphery incision. The jelly-like substance and fibrous substance of the submucosa 124 is led into the groove 64 of the side of the distal end portion of the probe 42 and fractured by the ultrasonic vibration of the probe 42. In this time, the fracturing is promoted by cavitation generated on the distal end and proximal end side ring shaped surfaces of the groove 64. The distal end portion of the probe 42 is further moved in the direction substantially parallel to the surface of the muscular layer 126 and crossing the central axis of the probe 42 to fracture the submucosa 124 and ablate the submucosa 124. In this time, as treatment is performed sideways of the distal end portion of the probe 42, the states of treatment can be visually confirmed sufficiently. In this way, a tissue specimen including the lesion region 118 is excised from a living tissue.

Step 8 and Step 9 (S8 and S9)

If a blood vessel is incised and bleeding occurs while ablating the submucosa 124, the high-frequency drive apparatus 100 is selected by the select apparatus 104 to be actuated, the probe 42 of the ultrasonic transducer 24 is used as the diathermy knife and hemostasis is performed by cauterizing the blood vessel. Then, the ultrasonic treatment apparatus 20 is removed from the accessory channel 86.

Step 10 (S10)

A grasping forceps is inserted into a body cavity through the accessory channel 86 and a tissue specimen is grasped and gathered.

Therefore, the ultrasonic treatment apparatus 20 of this embodiment provides the following effects.

As in the ultrasonic treatment apparatus 20 of the first embodiment, in the ultrasonic treatment apparatus 20 of this embodiment, cavitation is promoted by the groove 64 on the side of the distal end portion of the probe 42, sufficient treatment power is obtained and treatment can be performed by the side of the distal end portion of the probe 42.

As treatment can be performed by the side of the distal end portion of the probe 42, treatment is possible by moving the distal end portion of the probe 42 in the direction crossing the central axis of the probe 42. Therefore, as treatment is performed sideways of the distal end portion of the probe 42 when fracturing the submucosa, the states of treatment can be visually confirmed sufficiently and treatment can be securely performed. Contrarily, if a groove is not formed on the side of the distal end portion of the probe 142, as shown in FIG. 11, when fracturing the submucosa 124, the distal end portion of the probe 142 is moved in the direction of the central axis of the probe 142 as indicated by the arrow K in FIG. 11 and treatment is performed by the surface of the distal end portion of the probe 142. Therefore, as treatment is performed forward of the distal end portion of the probe 142, a visual field is disturbed by the probe 142 and submucosa 124, and the states of treatment are difficult to visually confirm.

The frequency f is 75.0 kHz≦f≦150.0 kHz, the distance l is λ/100.0≦l≦λ/8.0, and the ratio of transverse cross section areas St/S is 3.0≦St/S≦15.0 so that the total length from the distal end of the probe 42 to the proximal end of the ultrasonic transducer 24 is 50.0 mm or lower, sufficient treatment power is obtained, and the vibration velocity v is 5 m/sec≦v≦15 m/sec. Namely, the small treatment unit 112 provides sufficient treatment power with high energy efficiency.

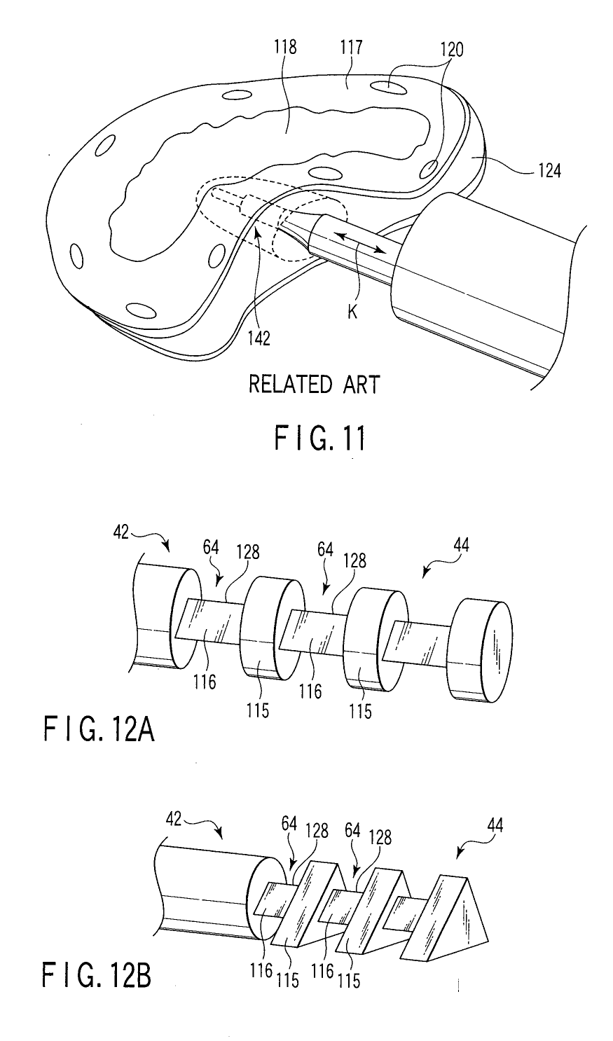

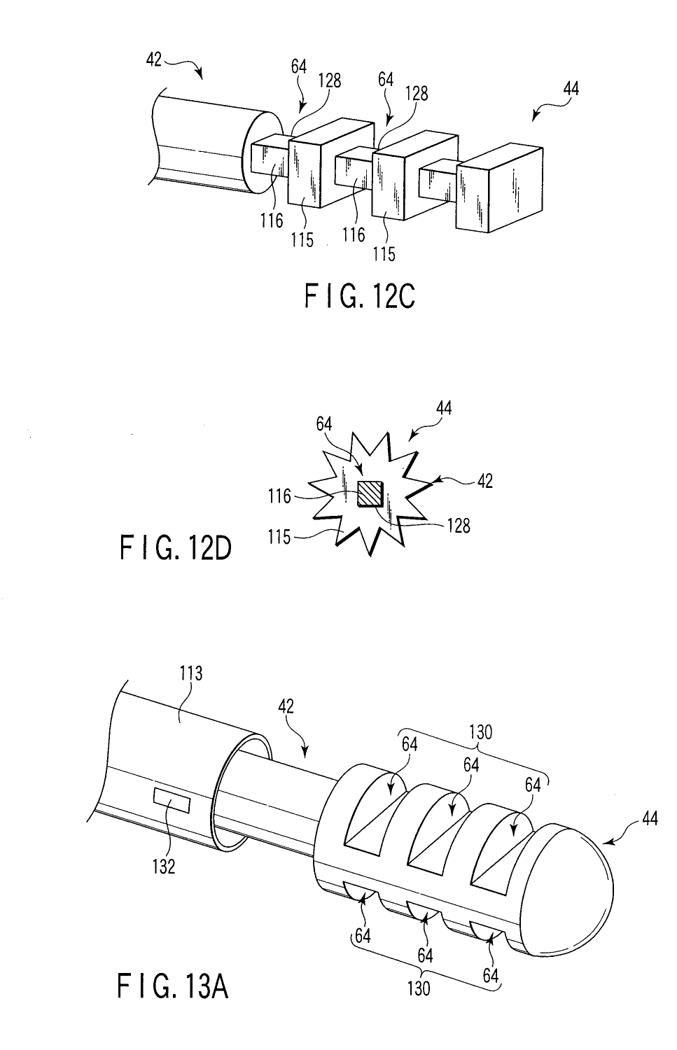

FIG. 12A shows a third embodiment of the invention.

The distal end portion of the probe 42 of this embodiment is circular cylindrical rod shaped. A plurality of the grooves 64 extending over all circumference of the probe 42 on the side of the distal end portion of the probe 42 is arranged side by side in the central axial direction of the probe 42. The grooves 64 is formed so that in the treatment portion 44, a circular cylindrical thick portion 115 and a triangular prism shaped thin portion 116 are sequentially and coaxially arranged in the central axial direction of the probe 42.

The method of using the ultrasonic treatment apparatus 20 of this embodiment is the same as the method of using the ultrasonic treatment apparatus 20 of the second embodiment. When fracturing the submucosa 124 by the ultrasonic treatment apparatus 20, the distal end portion of the probe 42 is moved in the direction crossing the central axis of the probe 42, the side of the distal end portion of the probe 42 is applied to the submucosa 124 and the submucosa 124 led into the groove 64 is fractured by the ultrasonic vibration of the probe 42. In this time, the edge 128 of the thin portion 116 functions as cutting the submucosa 124.

In the ultrasonic treatment apparatus 20 of this embodiment, sufficient treatment power can be obtained by the cutting function of the edge 128 of the thin portion 116 and the fracture promotion function by cavitation generated in the groove 64.

FIG. 12B shows a first modification of the third embodiment of the invention.

The distal end portion of the probe 42 of this embodiment is substantially triangular prism shaped. The grooves 64 is formed so that in the treatment portion 44, a triangular prism shaped thick portion 115 and a triangular prism shaped thin portion 116 are sequentially and coaxially arranged in the central axial direction of the probe 42.

FIG. 12C shows a second modification of the third embodiment of the invention.

The distal end portion of the probe 42 of this embodiment is substantially quadrangular prism rod shaped including a rectangular cross section. The grooves 64 is formed so that in the treatment portion 44, a quadrangular prism shaped thick portion 115 having a rectangular cross section and a quadrangular prism shaped thin portion 116 having a rectangular cross section are sequentially and coaxially arranged in the central axial direction of the probe 42.

FIG. 12D shows a third modification of the third embodiment of the invention.

The distal end portion of the probe 42 of this embodiment is substantially prism rod shaped having a star shaped cross section. The grooves 64 is formed so that in the treatment portion 44, a prism shaped thick portion 115 having a star shaped cross section and a prism shaped thin portion 116 having a rectangular cross section are sequentially and coaxially arranged in the central axial direction of the probe 42.

It is noted that the thin portion 116 may be circular cylindrical in the distal end portion of the probe 42 shown in FIGS. 12A-12D.

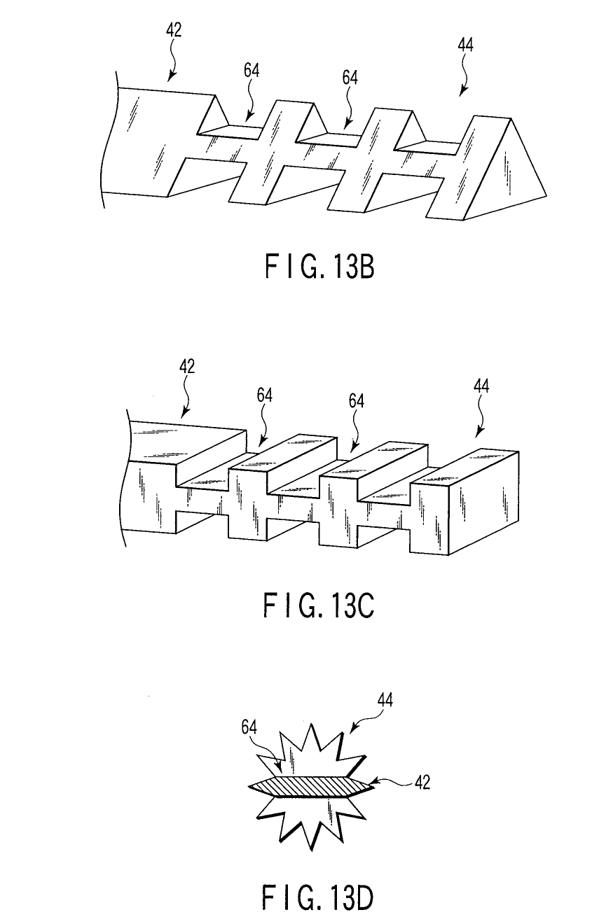

FIG. 13A shows a fourth embodiment of the invention.

The distal end portion of the probe 42 of this embodiment is substantially circular cylindrical rod shaped. The distal end portion of the probe 42 has a larger diameter than the proximal end portion. The groove 64 extends in the distal end portion of the probe 42 in the direction almost perpendicular to the central axis of the probe 42. A plurality of such grooves 64 is arranged side by side in the central axial direction of the probe 42. Such a groove row 130 is arranged symmetrically on one side and the other side with respect to the longitudinal cross section including the central axis of the probe 42. Cavitation is promoted in the distal end and proximal end side semicircle shaped surfaces of each groove 64.

An index 132 to indicate the position of the groove 64 in the probe 42 is provided on the outside surface of the distal end of the cylinder 113 provided onto the proximal end of the probe 42. In this embodiment, on the outside surface of the distal end of the cylinder 113, the index 132 is provided at the position where the groove row 130 is not provided with respect to the peripheral direction.

When fracturing the submucosa by the ultrasonic treatment apparatus 20 of this embodiment, the distal end of the endoscope 70 is moved by operating the endoscope control portion 80 to place the probe 42 of the ultrasonic treatment apparatus 20 so that the probe 42 is substantially parallel to the surface of the muscular layer 126 and the groove rows 130 on both sides of the distal end portion of the probe 42 is not faced to the surface of the muscular layer 126. The distal end portion of the probe 42 is moved in the direction substantially parallel to the surface of the muscular layer 126 from one side groove row 130 to the other side groove row 130 of the probe 42 to apply the other side groove row 130 of the distal end portion of the probe 42 to the submucosa 124 to fracture the submucosa 124 led into the groove 64 by the ultrasonic vibration of the probe 42. In this time, the fracturing is promoted by cavitation generated on the distal end and proximal end side semicircle shaped surfaces of the groove 64. As the groove 64 is provided on one side and the other side of the probe 42, cavitation is generated only on one side and the other side of the probe 42. The position of the groove 64 in the probe 42 can be recognized by visually confirming the position of the index 132 provided in the cover 23 in an observation image through the endoscope 70.

In the ultrasonic treatment apparatus 20 of this embodiment, as the groove 64 is provided on one side and the other side of the probe 42 as described above, cavitation is generated only on one side and the other side of the probe 42. Therefore, compared with the case that cavitation is generated in all circumference of the probe 42 as in the second embodiment, disturbance of the visual field by cavitation can be decreased.

FIGS. 13B to 13D show first to third modifications of the fourth embodiment of the invention.

The distal end portions of the probe 42 of the first to third modifications are substantially triangular prism rod shaped, quadrangular prism rod shaped having a rectangular cross section, and prism rod shaped having a star shaped cross section, respectively. As in the fourth embodiment, a plurality of grooves 64 extending in the direction almost perpendicular to the central axis of the probe 42 is arranged side by side in the central axial direction of the probe 42, on one side and the other side with respect to the longitudinal cross section including the central axis of the probe 42.

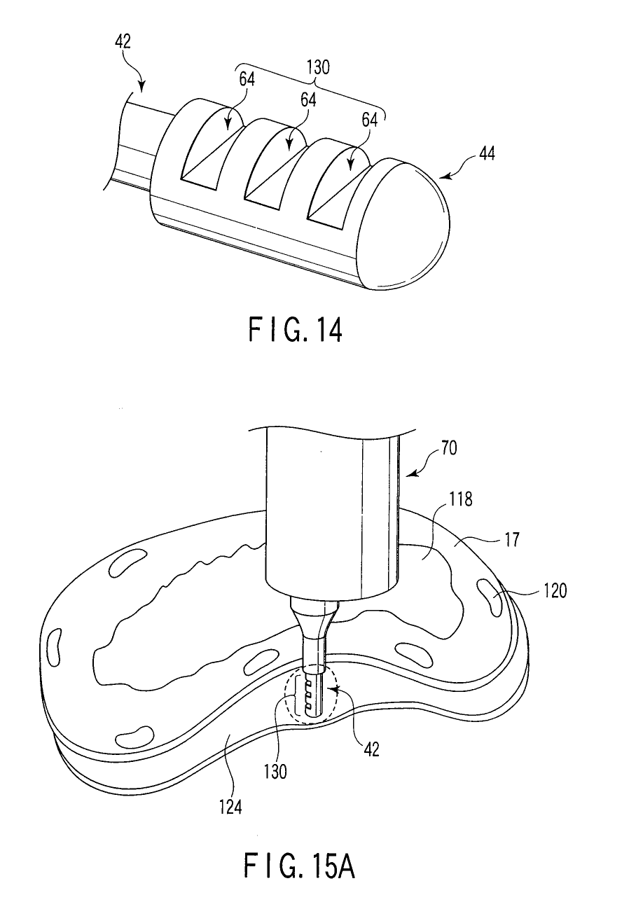

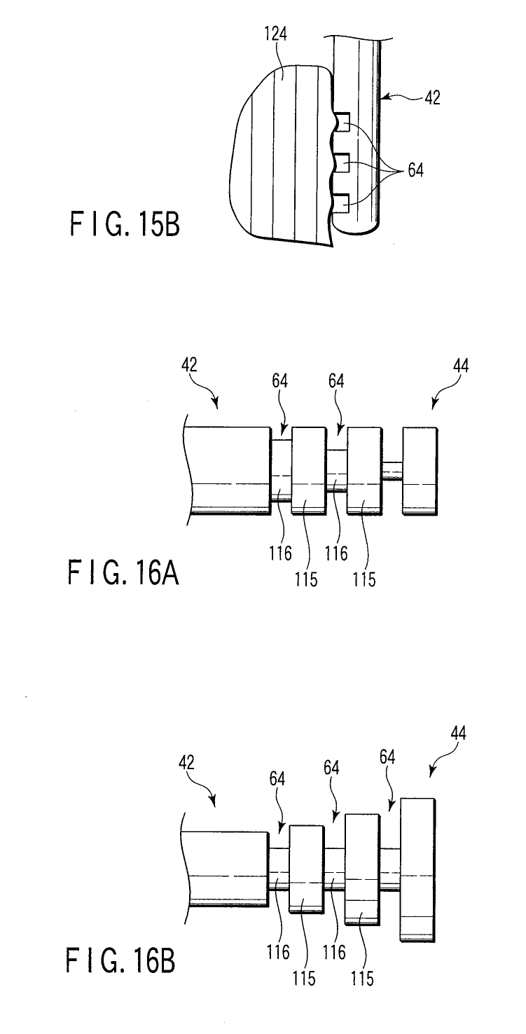

FIGS. 14 to FIG. 15B shows a fifth embodiment of the invention.

Reference to FIG. 14, in the distal end portion of the probe 42 of this embodiment, the groove row 130 is provided only on one side with respect to the longitudinal cross section including the central axis of the probe 42 in the distal end portion of the probe 42 of the fourth embodiment.

Reference to FIGS. 15A and 15B, when fracturing the submucosa by the ultrasonic treatment apparatus 20 of this embodiment, the distal end of the endoscope 70 is moved by operating the endoscope control portion 80 to place the probe 42 of the ultrasonic treatment apparatus 20 so that the probe 42 is substantially perpendicular to the surface of the muscular layer 126 and the groove row 130 in the distal end portion of the probe 42 is faced to the surface of the submucosa 124 exposed through the periphery incision. The bending portion 76 of the endoscope 70 is bended to move the distal end portion of the probe 42 from the other side not provided with the groove row 130 to one side provided with the groove row 130 to apply the groove row 130 on the side of the distal end portion of the probe 42 to the submucosa 124. Furthermore, the distal end portion of the probe 42 is moved in the extending direction of the groove 64 substantially parallel to the surface of the muscular layer 126 to fracture the submucosa 124 led into the groove 64 by the ultrasonic vibration of the probe 42. In this time, the fracture is promoted by cavitation generated on the distal end and proximal end side semicircular shaped surfaces of the groove 64. As the groove 64 is provided on one side of the probe 42, cavitation is generated only on one side of the probe 42 where treatment is performed.

In the ultrasonic treatment apparatus 20 of this embodiment, as the groove 64 is provided only on one side of the probe 42 as described above, cavitation can be generated only on one side of the probe 42 where treatment is performed. Therefore, compared with the case where cavitation is generated on both sides of the probe 42 including the side where treatment is not performed, disturbance of the visual field by cavitation can be decreased furthermore.

FIG. 16A shows a sixth embodiment of the invention.

In this embodiment, an area of a projection surface of the groove 64 onto the transverse cross section perpendicular to the central axis of the probe 42 is larger to more distal end side.

Namely, reference to FIG. 16A, the probe 42 of this embodiment is substantially circular cylindrical rod shaped. On the side of the distal end portion of the probe 42, a plurality of the grooves 64 extending over all circumference of the probe 42 is arranged side by side in the central axial direction of the probe 42. The depth of the more distal end side groove 64 is deeper. Namely, in the treatment portion 44, the circular cylindrical thick portions 115 and the circular cylindrical thin portions 116 are arranged sequentially and coaxially in the central axial direction of the probe 42, and the outside diameter is smaller in the more distal end side thin portion 116. The area of the distal end and proximal end side ring shaped surfaces of the groove 64 is larger in the more distal end side groove 64 and the effect of promotion of cavitation is greater in the more distal end side groove 64.

The method of using the ultrasonic treatment apparatus 20 of this embodiment is the same as the method of using the ultrasonic treatment apparatus 20 of the second embodiment. As the effect of promotion of cavitation is greater in the more distal end side groove 64 as described above, when fracturing the submucosa 124 by the distal end portion of the probe 42, cavitation is more generated to the more distal end side in the distal end portion of the probe 42. Namely, cavitation is less generated in the more proximal end side portion of the distal end portion of the probe 42, disturbance of visual field by cavitation is less and treatment can be more securely and easily.

FIG. 16B shows a modification of the sixth embodiment of the invention.

In the treatment portion 44 of this modification, the circular cylindrical thick portions 115 and the circular cylindrical thin portions 116 are arranged sequentially and coaxially in the central axial direction of the probe 42, and the outside diameter is larger in the more distal end side thick portion 115. Namely, the area of the distal end side ring shaped surface is larger than the area of the proximal end side ring shaped surface in each groove 64, the area of the more distal end side ring shaped surface is larger and the effect of promotion of cavitation is larger in the more distal end side groove 64.

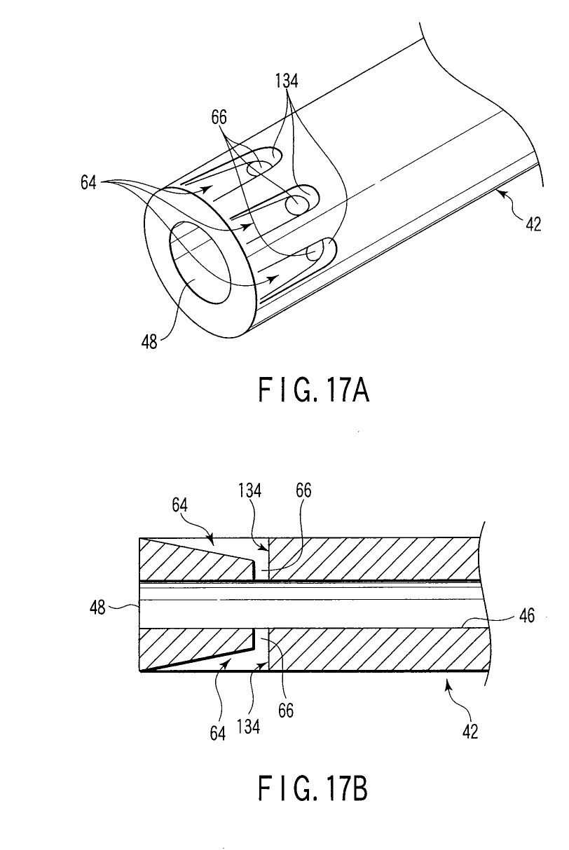

FIGS. 17A and 17B show a seventh embodiment of the invention.

The ultrasonic treatment apparatus 20 of this embodiment has the configuration similar to the ultrasonic treatment apparatus 20 of the first embodiment. In the distal end portion of the probe 42, the groove 64 extends from the distal end of the probe 42 in the axial direction of the probe 42 and a plurality of grooves 64 is arranged parallel to each other and side by side in the circumferential direction of the probe 42. The groove 64 becomes deeper from the distal end side to the proximal end side. A side hole 66 is formed at the proximal end of the groove 64. The proximal end surface 134 of the groove 64 close to the side hole 66 is substantially perpendicular to the central axial direction of the probe 42. Cavitation is promoted in the proximal end surface 134.

The method of using the ultrasonic treatment apparatus 20 of this embodiment is the same as the method of using the ultrasonic treatment apparatus 20 of the first embodiment. When sucking and collecting the emulsified and fractured fatty tissue 68, suck the tissue through the suction opening 48 and side hole 66 of the probe 42. The side hole 66 is relatively small and easy to be clogged. But, as cavitation is promoted on the proximal end surface 134 of the groove 64, the clogging of the side hole is prevented.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An ultrasonic treatment apparatus comprising:
an ultrasonic transducer to generate ultrasonic vibration;
a probe a proximal end of which is connected to the ultrasonic transducer and which extends from a proximal end side to a distal end side; and
a treatment portion which is formed in a distal end portion of the probe, includes at least one recess formed on the side of the probe and treats a living tissue by ultrasonic vibration generated by the ultrasonic transducer.

2. The ultrasonic treatment apparatus according to claim 1, wherein f is a frequency of ultrasonic vibration in the ultrasonic treatment apparatus and 20.0 kHz≦f≦50.0 kHz.

3. The ultrasonic treatment apparatus according to claim 1, wherein X is a wavelength of ultrasonic vibration in the ultrasonic treatment apparatus, 1 is a distance from a distal end of the probe to a most proximal end of the recess in a central axial direction of the probe and λ/100.0≦l≦λ/8.0.

4. The ultrasonic treatment apparatus according to claim 3, wherein λ/20.0≦l≦λ/12.0.

5. The ultrasonic treatment apparatus according to claim 1, wherein S is a transverse cross section area of a rod portion, which is an area of a transverse cross section of the probe perpendicular to a central axis of the probe in the treatment portion, St is a total transverse cross section area of the recess, which is a total area of projection surfaces of a surface of the recess onto a transverse cross section perpendicular to a central axis of the probe and 3.0≦St/S≦15.0.

6. The ultrasonic treatment apparatus according to claim 5, wherein 6.0≦St/S≦10.0.

7. The ultrasonic treatment apparatus according to claim 1, wherein v is a vibration velocity of ultrasonic vibration in the ultrasonic treatment apparatus and 5.0 m/sec≦v≦15.0 m/sec.

8. The ultrasonic treatment apparatus according to claim 1, wherein the recess extends over all circumference of the probe.

9. The ultrasonic treatment apparatus according to claim 1, wherein the recess is provided on one side and the other side with respect to a longitudinal cross section including a central axis of the probe.

10. The ultrasonic treatment apparatus according to claim 1, wherein the recess is provided on one side with respect to a longitudinal cross section including a central axis of the probe.

11. The ultrasonic treatment apparatus according to claim 1, wherein the recess is formed so that an area of a projection surface of the recess onto a transverse cross section perpendicular to a central axis of the probe is larger to a more distal end side.

12. The ultrasonic treatment apparatus according to claim 1, wherein the probe includes a suction path extending along a central axis of the probe and suction path includes a suction opening opened in the recess.

13. The ultrasonic treatment apparatus according to claim 1, wherein the ultrasonic treatment apparatus is configured to be inserted through an accessory channel of an endoscope.

14. The ultrasonic treatment apparatus according to claim 1, wherein the probe and ultrasonic transducer are formed on one body, λ is a wavelength of ultrasonic vibration in the ultrasonic treatment apparatus and a length from a distal end of the probe to a proximal end of the ultrasonic transducer is approximately λ/2.

15. The ultrasonic treatment apparatus according to claim 14, wherein f is a frequency of ultrasonic vibration in the ultrasonic treatment apparatus and 75.0 kHz≦f≦150.0 kHz.

16. The ultrasonic treatment apparatus according to claim 15, wherein f=100.0 kHz.

17. The ultrasonic treatment apparatus according to claim 1, wherein the ultrasonic transducer includes an electrode connectable to an ultrasonic drive apparatus to supply power for ultrasonic vibration of the ultrasonic transducer, the electrode is connectable to a high-frequency drive apparatus to supply a high-frequency current to the electrode and the probe is configured to supply a high-frequency current supplied to the electrode to a living tissue.

18. An ultrasonic treatment apparatus comprising:
an ultrasonic transducer to generate ultrasonic vibration;
a probe a proximal end of which is connected to the ultrasonic transducer and which extends from a proximal end side to a distal end side;
a treatment portion which is formed in a distal end portion of the probe, includes at least one recess formed on the side of the probe and extending from a distal end of the probe in a longitudinal direction of the probe, and treats a living tissue by ultrasonic vibration generated by the ultrasonic transducer;
a suction path extending in a longitudinal direction of the probe in the probe;
one or more side hole which connect to the suction path, extends in a radial direction of the probe and forms an opening portion in a proximal end portion of the recess; and
a proximal end surface which is formed in the opening portion of the side hole in the recess and substantially perpendicular to a longitudinal direction of the probe.

19. A treatment method comprising:
moving a distal end portion of a probe extending from a proximal end side to a distal end side in the direction crossing a central axis of the probe;
applying a side of a distal end portion of the probe provided with at least one recess to a living tissue; and
treating a living tissue applied by the side of a distal end portion of the probe by ultrasonic vibration of the probe.

20. The treatment method according to claim 19, for removing a fatty tissue and exposing a funicular tissue, wherein the treating a living tissue includes emulsifying and fracturing a fatty tissue around a funicular tissue.

21. The treatment method according to claim 19, for ablating a submucosa, wherein the treating a living tissue includes fracturing a submucosa.
